(19) United States
(12) Patent Application Publication
(10) Pub. No.: US 2023/0120423 A1
(43) Pub. Date: Apr. 20, 2023

(54) MUSHROOM HANDLING APPARATUS

(71) Applicant: Axis Technology and Development Limited, Gilford, County Down (GB)

(72) Inventor: George Ivan Doake, Gilford, County Down (GB)

(21) Appl. No.: 18/009,924

(22) PCT Filed: Jun. 10, 2021
(86) PCT No.: PCT/EP2021/065666

§ 371 Date: Dec. 12, 2022

(30) Foreign Application Priority Data
Jun. 12, 2020 (GB) 2008949.6

(51) Int. Cl. B65G 47/46; A01G 18/62; B65G 1/06; B65G 17/32; B65G 17/34; B07C 5/07

(52) U.S. Cl. CPC B65G 47/46; A01G 18/62; B65G 1/06; B65G 17/323; B65G 17/34; B07C 5/07; B65G 2201/0202

(57) ABSTRACT

A mushroom handling apparatus includes a frame, a mushroom transfer device, and a first guide extending around mushroom growing beds. Mushroom holders are mounted at spaced locations along the first guide. A drive moves the mushroom holders to transfer mushrooms between growing beds and a mushroom transfer region. A mushroom handling device adjacent the transfer device incorporates a second guide that at least partially overlaps the first guide in the transfer region. Mushroom grippers are mounted on the second guide, the mushroom holders and mushroom grippers being indexed on the guides such that the grippers are aligned with respective mushroom holders in the transfer region to transfer the mushrooms from the holders to the grippers. A lift adjusts the height of the frame with respect to vertically tiered shelving to bring the mushroom transfer device and mushroom handling device into vertical alignment with selected vertically tiered growing beds.

### CROSS REFERENCE TO RELATED APPLICATIONS

The present application is a § 371 national stage of International Application PCT/EP2021/065666, filed Jun. 10, 2021, which claims priority benefit of U.K. Pat. Application Ser. No. 2008949.6, filed Jun. 12, 2020, both of which are hereby incorporated herein by reference in their entireties.

### FIELD OF THE INVENTION

The present invention relates to a mushroom handling apparatus for use in the handling, grading and packing of mushrooms.

### BACKGROUND OF THE INVENTION

It is a well established practice in the trade of mushroom growing to provide custom built growing houses in which the mushrooms may be grown in a carefully maintained environment. Mushrooms are usually commercially cultivated in a growing medium provided in trays arranged in vertically tiered relationship on suitable shelving, the trays being located within a growing house which serves to shut out sunlight and provide a controlled environment, in terms of temperature and humidity conditions. Each tray or tier of trays defines a growing bed containing compost, on which the mushrooms are grown. Rows of shelving each having vertically tiered trays are usually separated by passages running therebetween. Therefore, when harvesting the mushrooms, pickers travel along the passages between the rows of shelving, manually picking the mushrooms from the growing beds and depositing them in a basket or similar punnet for subsequent sorting and packing.

It is also known in the art to provide a custom built trolley having a conveyor on which the picked mushrooms are deposited, the trolley further including a number of punnets into which the mushrooms are deposited from the conveyor. The conveyor may be arranged to manually grade the mushrooms by size, such that each punnet includes only mushrooms within a given size range. Once one of the punnets has been filled with mushrooms, the picker must cease picking, remove the punnet from the trolley, and deposit the punnet in a suitable location for further processing.

Having removed the filled punnet from the trolley, the picker must then get an empty punnet and position it on the trolley in place of the filled punnet which has been removed. Once this has been effected, the picker may resume picking mushrooms from the bed. It will therefore be appreciated that the picker must also continually observe the punnets in the trolley, while simultaneously trying to pick mushrooms, in order to ensure that none of the punnets overflow.

### SUMMARY OF THE INVENTION

The present invention to provides a mushroom handling apparatus which is capable of receiving hand picked mushrooms and transporting them from a growing bed to a processing station, such as a sorting and packaging station, without interruption of the picking process and with minimal manual intervention. Optionally, the mushroom packing apparatus automatically sorts the picked mushrooms by size.

According to the present invention there is provided a mushroom handling apparatus for handling mushrooms grown in a plurality of vertically spaced mushroom growing beds arranged on trays in vertically tiered relationship on shelving, the apparatus including a frame, a mushroom transfer device being mounted on the frame and incorporating a first guide adapted to extend circumferentially around the mushroom growing beds, a plurality of mushroom holders being mounted on the first guide at spaced locations therealong, a drive being associated with the first guide for moving the mushroom holders to transfer mushrooms carried thereon between the mushroom growing beds and a mushroom transfer region at one end of the frame, and a mushroom handling device mounted adjacent the mushroom transfer device and incorporating a second guide, a portion of the second guide overlapping at least a portion of the first guide in the transfer region, a plurality of mushroom grippers being mounted on the second guide, the mushroom holders and mushroom grippers being indexed on the first and second guide such that the mushroom grippers are aligned with respective mushroom holders in the transfer region to facilitate transfer the mushrooms between the holders of the mushroom transfer device to the grippers of the mushroom handling device, a lift being provided for adjusting the height of the frame with respect to the shelving to bring the mushroom transfer device and mushroom handling device into vertical alignment with selected vertically tiered growing beds.

Optionally, the frame is adapted to be supported on the shelving and/or an adjustment lifting frame. Selectively operable locking devices may be provided for locking the frame at a selected height on the shelving. The locking devices may be biased to a locked position to prevent uncontrolled movement of the support frame with respect to the shelving, actuators being provided for selectively releasing the locking devices from a locked state.

A cutter may be provided for cutting off the stem of mushrooms as they are carried by the mushroom holders of the mushroom transfer device. The cutter may be located on the support frame in the transfer region.

Each mushroom holder of the mushroom transfer device may have a base portion and a pair of spaced apart fingers extending outwardly from the base portion to be located on either side of the stem of a mushroom such that the cap of the mushroom is supported upon the fingers.

Optionally, each mushroom gripper of the mushroom handling device includes a pair of mushroom gripping members displaceable towards and away from one another to selectively engage either side of the cap of a mushroom carried by an adjacent mushroom holder, wherein the gripping members of each gripper are arranged to engage mushrooms carried by respective mushroom holders when aligned therewith to transfer mushrooms between the first and second guide in the transfer region. Each mushroom gripper may be vertically displaceable at least in the transfer region to facilitate transfer of a mushroom from a respective mushroom holder to a respective mushroom gripper. The gripping members of each gripper may be biased towards one another to grip a mushroom therebetween, actuators being provided for selectively displacing the gripping members away from one another. A controller may be arranged for operating the actuator of each mushroom gripper of the mushroom handling device, at least in the transfer region, such that the gripping members selectively engage either side of the cap of a mushroom carried by an adjacent mushroom holder of the mushroom transfer device to engage mushrooms carried by respective mushroom holders when aligned therewith to transfer mushrooms between the mushroom transfer device and the mushroom handling device in the transfer region.

The actuator of each mushroom gripper may include an operating member extending from each mushroom gripper and having an inner end acting against respective operating levers to urge the respective gripping members away from one another, the controller having at least one control surface acting upon an outer end of the operating member to control the spacing between the gripping members of each mushroom gripper as the gripper moves past the control surface.

Each mushroom gripper of the mushroom handling device may be associated with a release mechanism adapted to release a mushroom held by a respective mushroom gripper at a selected one or a plurality of positions in a sorting region as a function of the distance between the gripping members of each mushroom gripper when a respective mushroom is held therein, thereby sorting the mushrooms by size. Optionally, a respective punnet is located at each of the plurality of selected positions for receiving the sorted mushrooms. The release mechanism may include a control surface defining a grading member arranged to engage the operating member of the operating mechanism of each gripper as it passes through the sorting region, to release a mushroom held therein at a respective one of the plurality of positions depending upon the distance between the gripping members of the respective gripper. The control surface defining the grading member may be arranged an inclined angle with respect to the path the mushroom grippers in the sorting region.

In one embodiment the first guide may be an endless flexible member, such as a chain, extending between guide members, such as sprockets. The second guide may be a guide rail upon which the plurality of mushroom grippers are supported and/or guided.

According to a further aspect of the present invention there is provided a mushroom growing assembly including shelving defining a plurality of vertically spaced mushroom growing beds arranged in vertically tiered relationship and a mushroom handling apparatus in accordance with the first aspect of the present invention mounted on the shelving.

Mushrooms may be transferred from the growing beds to a transfer region via the mushroom transfer device and from the transfer region to a sorting region via the mushroom handling device. The mushroom handling device may be adapted to sort the mushrooms by size and deliver sorted mushrooms to respective punnets.

The gripping members of each gripper may be biased towards one another to grip a mushroom therebetween, an actuator being provided for selectively displacing the gripping members away from one another. A controller may be arranged for operating the operating the actuator of each mushroom gripper, at least in the transfer region, such that the gripping members selectively engage either side of the cap of a mushroom carried by an adjacent mushroom holder to engage mushrooms carried by respective mushroom holders when aligned therewith to transfer mushrooms between the first and second guide in the transfer region.

In one embodiment the actuator of each mushroom gripper may have an operating member extending from each mushroom gripper and having an inner end acting against respective operating levers to urge the respective gripping members away from one another, the controller having at least one control surface acting upon an outer end of the operating member to control the spacing between the gripping members of each mushroom gripper as the gripper moves past the control surface.

Each mushroom gripper may be associated with a release mechanism adapted to release a mushroom held by a respective mushroom gripper at a selected one or a plurality of positions in the sorting region as a function of the distance between the gripping members of each mushroom gripper when a respective mushroom is held therein, thereby sorting the mushrooms by size. A respective punnet may be located at each of the plurality of selected positions. Means may be provided for replacing the punnets when full. The punnet replacer may be adapted to transfer full punnets onto a conveyor.

As used herein, the term “mushroom growing bed” is intended to mean compost bags, compost blocks, trays or shelves containing compost or the like, or any other similar growing systems in which mushrooms are grown, the beds generally being arranged in vertically stacked relationship in elongate rows of shelving having corresponding passages therebetween, which passages allow access to the beds for the purpose of harvesting the mushrooms.

These and other objects, advantages, purposes and features of the present invention will become apparent upon review of the following specification in conjunction with the drawings.

### BRIEF DESCRIPTION OF THE DRAWINGS

A mushroom handling apparatus in accordance with an embodiment of the present invention will now be described, by way of example only, with reference to the accompanying drawings, in which;

FIG. 1 is a side view of a mushroom handling apparatus in accordance with an embodiment of the present invention;

FIG. 2 is a plan view of part of the apparatus of FIG. 1;

FIG. 3 is a detailed perspective view of the apparatus of FIG. 1;

FIGS. 4 and 5 are detailed views of the ratchet locking system of the apparatus of FIG. 1;

FIG. 6 is a detailed perspective view of the mushroom transfer device of the apparatus of FIG. 1;

FIGS. 7 to 9 are detailed perspective views of the transfer region of the apparatus of FIG. 1;

FIG. 10 is a perspective view of a mushroom gripper of the apparatus of FIG. 1;

FIG. 11 is a side view of the mushroom gripper of FIG. 10; and

FIGS. 12 to 15 are front views of the mushroom gripper of FIG. 10 illustrating the operation thereof.

### DETAILED DESCRIPTION OF THE DRAWINGS

Referring now to the accompanying drawings, there is illustrated a mushroom handling apparatus in accordance with an embodiment of the present invention, for expediting the picking and packing of mushrooms 1 grown on tiered growing beds 4 supported on vertically tiered trays provided on shelving 2, the apparatus having a mushroom transfer unit 10 for conveying mushrooms between the growing beds and a transfer region, and a mushroom sorting unit 20 for conveying the mushrooms between the transfer region and a sorting region, wherein the mushrooms are automatically sorted by size and delivered into punnets.

The mushroom transfer unit 10 and mushroom sorting unit 20 are mounted on a common support frame 30 supported on the shelving 2. The mushroom transfer unit 10 is mounted on the support frame 30 to extend around the growing beds 4 for conveying mushrooms 1 between the growing beds 4 and a transfer region and the mushroom sorting unit 20 is mounted on one end region of the support frame 30 adjacent the mushroom transfer unit 10 for transferring mushrooms 1 between the transfer region and sorting region.

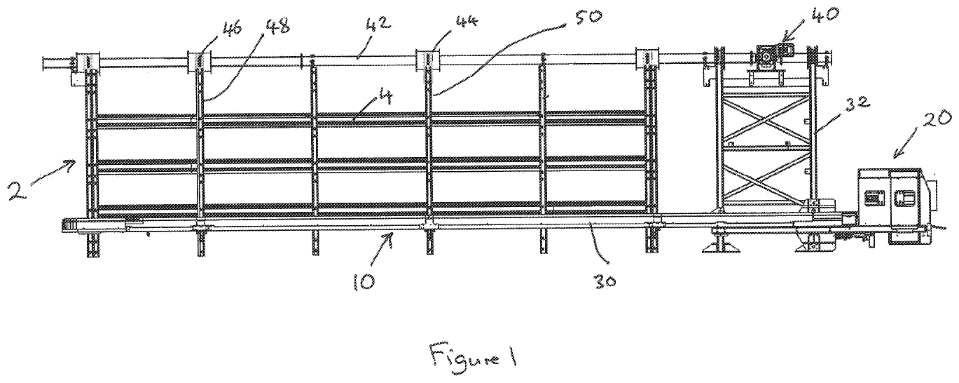

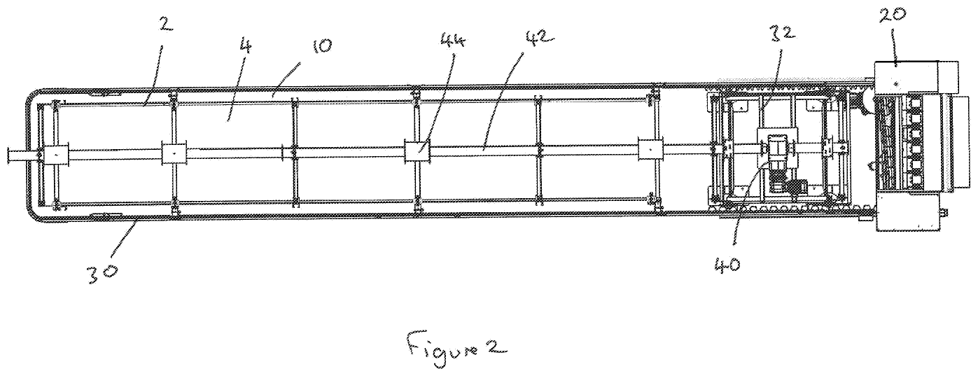

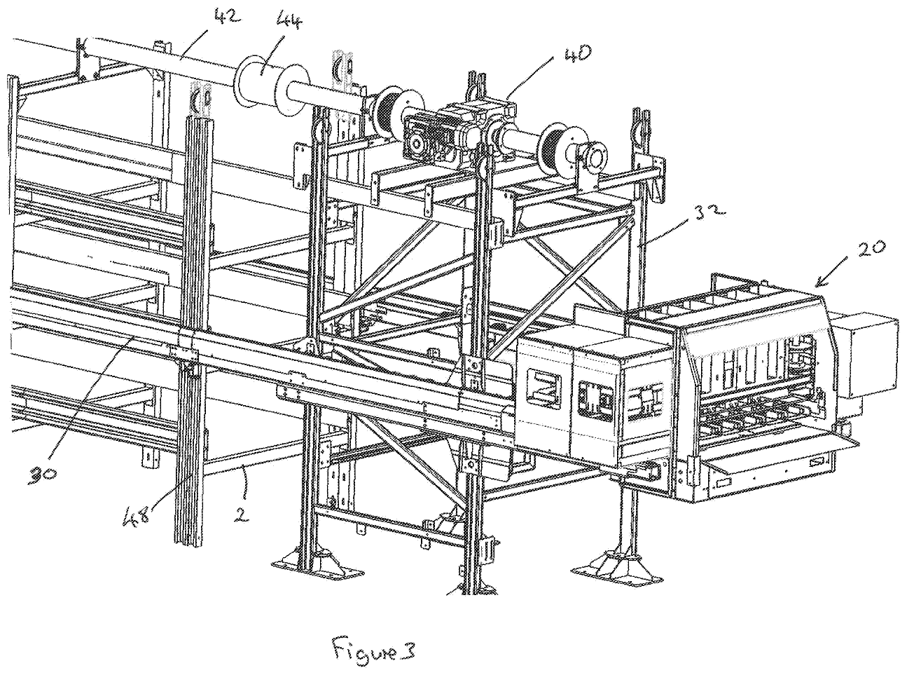

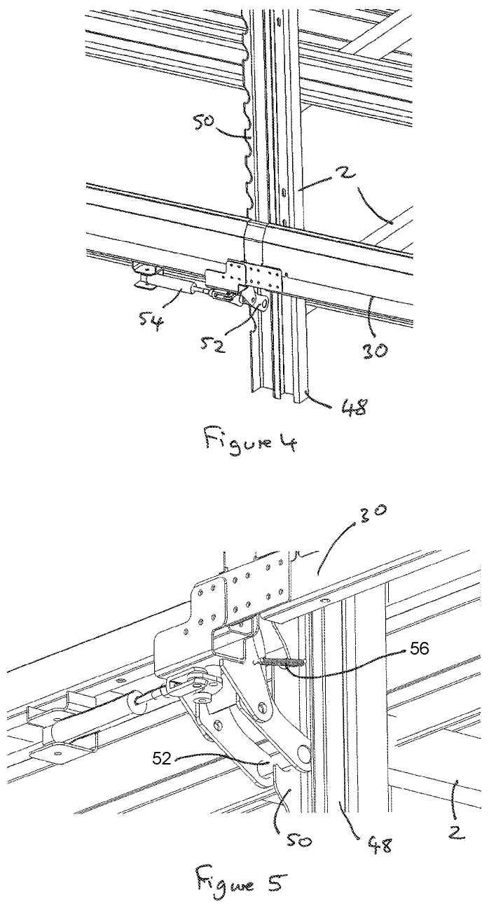

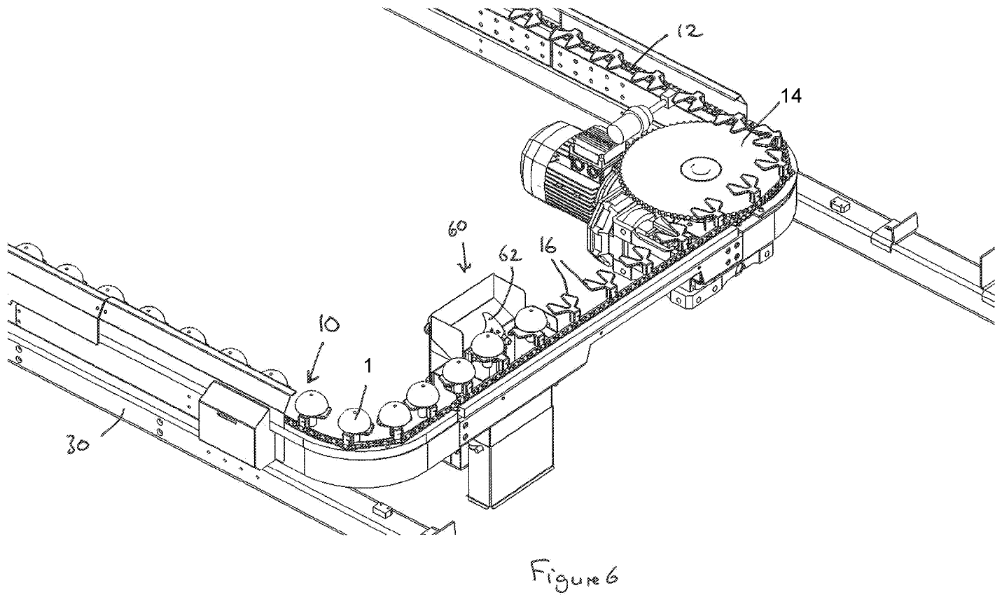

The support frame 30 is supported on the shelving 2 via a lifting mechanism adapted to raise and lower the support frame 30 with respect to the shelving 2 to bring the mushroom transfer unit 10 and sorting unit 20 level with a selected tier of the mushroom growing beds 4. In the embodiment shown, the lifting mechanism includes a winch assembly 40 mounted on the top of a lifting frame 32 provided adjacent one end of the shelving 2, as illustrated in FIG. 1. The winch assembly 40 may include a common motor driven shaft 42 extending along the top of the shelving 2 parallel to a longitudinal axis of the shelving, axially spaced lifting pulleys 44 being mounted upon the shaft 42 and upon which are wound lifting cables 46 coupled to the support frame 30 at spaced locations therealong. As the shaft 42 of the winch assembly 40 rotates, under the action of a drive motor, the lifting cables 46 wrap around the lifting pulleys 44 mounted on the shaft 42, and thereby adjust the height of the support frame 30, and the mushroom transfer unit 10 and mushroom sorting unit 20 mounted thereon, with respect to the tiered growing beds 4 on the shelving 2.

The support frame 30 may be coupled to a plurality of upright guide channels 48 provided on the shelving 2 and the adjacent lifting frame 32, within which mounting portions of the support frame 30 are slideably guided to guide vertical movement of the support frame 30 with respect to the shelving 2. The height of the support frame 30 with respect to the growing beds 4 on the shelving 2 may be controlled by limit switches adjacent each tier of the shelving 2 and at the top and bottom of the shelving. The mushroom sorting unit 20 is mounted on one end of the support frame 30 via the two laterally extending ‘lifting forks’. Park position switches may be provided to define a park position of the support frame 30, such as at its uppermost position on the shelving 2, which position may be used when the mushroom handling apparatus is inactive to facilitate access to the growing beds 4.

A ratchet locking system may be provided for automatically locking the support frame 30 with respect to the shelving 2. The ratchet locking system may have several upright toothed rails 50 mounted on the shelving 2 and/or lifting frame 32 adapted to be engaged by spring loaded latches 52 mounted on the support frame 30. An actuator 54, such as an air cylinder and cam assembly, may be associated with each latch 52 to urge the latch 52 to a release position against the restoring force of a return spring 56, the spring 56 biasing each latch 52 into engagement with the respective toothed rail 50.

As the support frame 30 is raised with respect to the shelving 2, the return springs 56 keeps the latches 52 engaged with the toothed rails 50 and hence the locking system engaged. When it is desired to lower the support frame 30 with respect to the shelving 2, the actuator 54 of each latch 52 is operated to urge the respective latch 52 to its release position, for example by applying pressurised air to the respective air cylinders, disengaging the locking system and allowing the support frame 30 to be lowered with respect to the shelving 2 in safety.

The mushroom transfer unit 10 may utilize an endless chain 12 mounted on guide sprockets 14 to extend around the periphery of the support frame 30 and thereby around the tiers of mushroom growing beds 4. A plurality of spaced apart mushroom holders 16 are mounted on the chain 12, each mushroom holder 16 having a base portion and pair of spaced apart fingers extending substantially horizontally and outwardly from the base portion to be located on either side of the stem of a mushroom 1, such that the cap of the mushroom can be supported upon the fingers of each holder 16.

With the support frame 30 brought into vertical alignment with a selected tier of the vertically stacked mushroom growing beds 4, the mushrooms 1 are picked and placed onto individual mushroom holders 16 of the mushroom transfer unit 10 as the holders 16 move past the mushroom growing bed 4, each mushroom 1 being placed onto a respective holder 16 with the stalk located between the fingers and the cap supported on top of the fingers. The fingers of each mushroom holder 16 may diverge outwardly from one another to facilitate location of a mushroom into a respective holder 16. At least an outer region of the fingers of each holder 16 may be inclined upwardly to facilitate retention of a mushroom 1 on a respective mushroom holder 16. The mushroom holders 16 may be arranged on the chain 12 of the mushroom transfer unit 10 such that the fingers face towards the adjacent growing bed.

An operator platform (not shown) may be provided on the support frame, adjacent at least a loading region of the mushroom transfer device, for example extending around three sides of the selected growing bed, such that the height of the operator platform can be adjustable by raising and lowering the support frame 30 with respect to the shelving 2 and so that the operator platform may be maintained in alignment with the mushroom transfer unit 10.

The mushrooms 1, carried by the mushroom holders 16 of the mushroom transfer unit 10, proceed to a transfer region where they are transferred to the mushroom sorting unit 20, the mushroom sorting unit 20 adapted to sort the mushrooms by size, as will be described in more detail below.

The fingers or adjacent portions of each mushroom holder 16 may be provided with weakened portions along which the holder 16 may break should it contact obstructions to prevent injury.

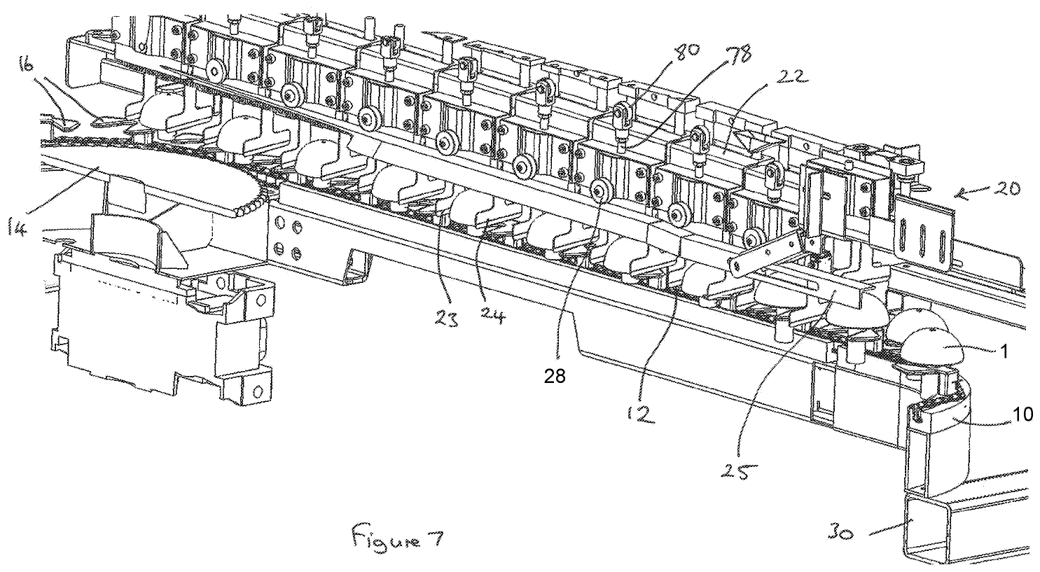

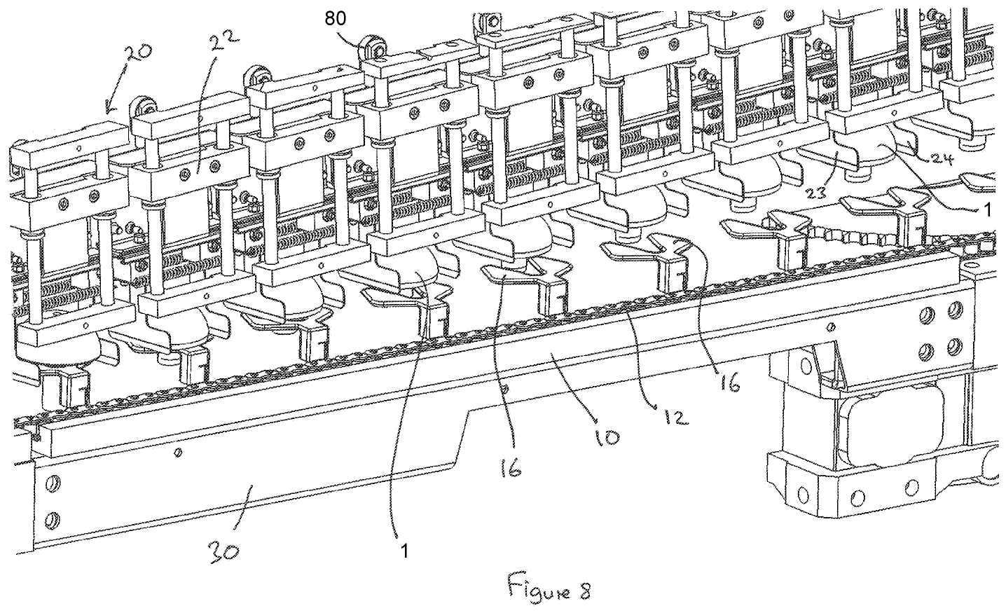

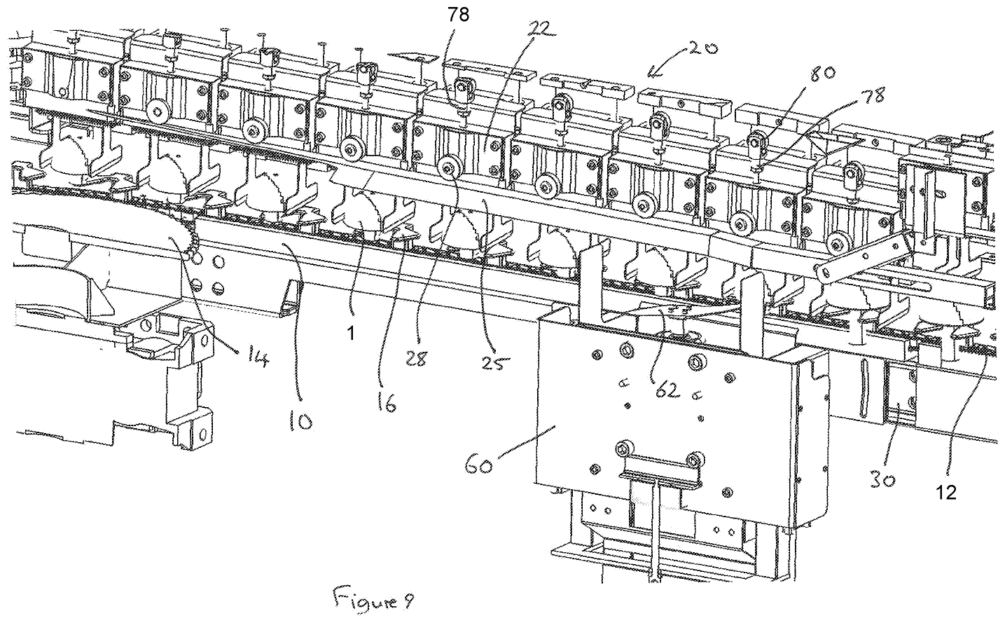

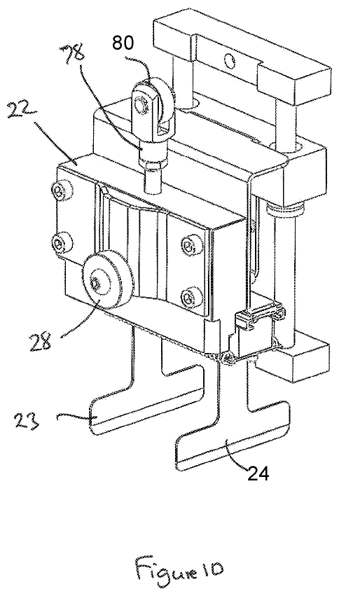

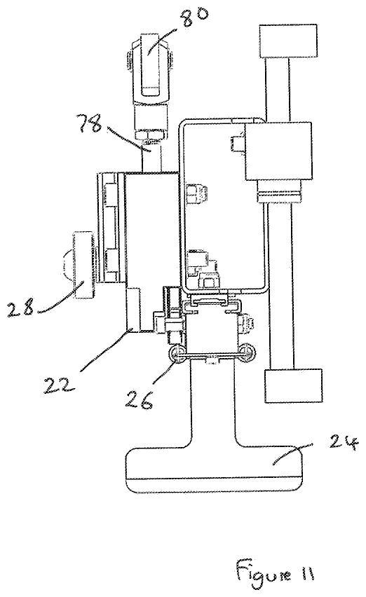

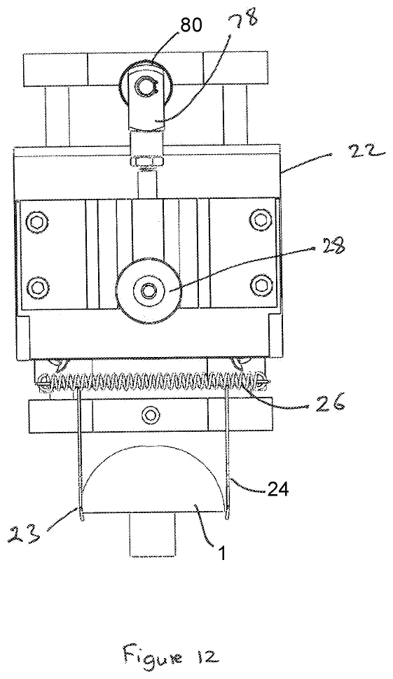

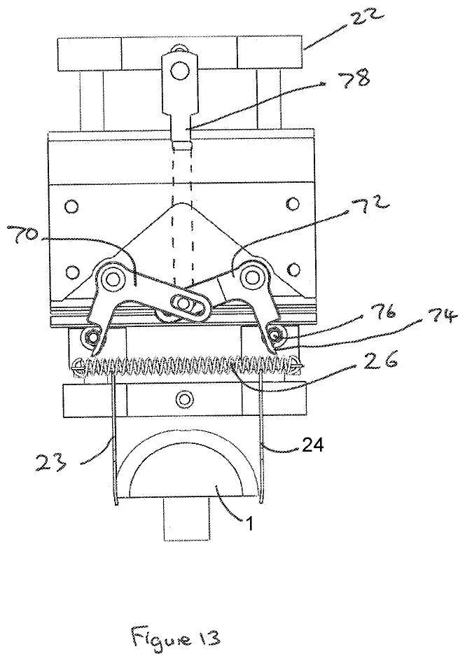

As illustrated in FIGS. 6 and 7, a cutting system 60 may be provided for cutting the stalks of the mushrooms 1 as they are conveyed on the mushroom holders 16 of the mushroom transfer unit 10. The cutting system 60 may be associated with the transfer region. In one embodiment the cutting system 60 may have a rotary blade 62 driven at high speed, for example up to 10,000 rpm, the 62 blade extending into the path of and below the mushroom holders 16 to cut the stalks as the mushrooms are conveyed on the holders 16 past the cutting system 60. The blade 62 may be adjustable vertically with respect to the mushroom holders 16 to adjust the length at which the stalks are cut. The blade may be rotated by a stepper or servo motor which rotates the blade only when it is required to cut the stalk of a mushroom, the rotation of the blade being configured to be synchronised with the movement of the mushroom holders 16 on the mushroom transfer unit 10.

The mushroom sorting unit 20 may include a plurality of spaced apart mushroom grippers 22 displaceable along a guide track or rail between the transfer region and the sorting region. The mushroom grippers 22 of the sorting unit 20 are indexed with the mushroom holders 16 of the mushroom transfer unit 10 when in the transfer region and are adapted to engage and remove mushrooms 1 from respective mushroom holders 16, as will be described below in more detail.

Each mushroom gripper 22 includes a pair of vertically depending mushroom gripping members 23,24 displaceable towards and away from one another to selectively engage either side of the cap of a mushroom 1, wherein the gripping members 23,24 of each gripper 22 are arranged to engage the cap of a mushroom 1 carried by a respective mushroom holder 16 when aligned therewith to transfer mushrooms 1 between the transfer unit 10 and sorting unit 20 in the transfer region.

The gripping members 23, 24 of each mushroom gripper 22 may be biased towards one another by a suitable biasing means, such as a spring 26, and an actuating mechanism may be provided for selectively moving the gripping members 23,24 apart, for example as the respective gripper 22 is lowered into alignment with a mushroom 1 held by a respective mushroom holder 16 of the mushroom transfer unit 10. A control mechanism of the grippers 22 may include operating abutments, levers or cams adapted to engage an operating portion of the actuating mechanism respective gripping members 23,24 of the grippers 22 as they move past.

A guide rail 25 may be adapted to control the height of each mushroom gripper 22 with respect to the adjacent mushroom holders 16 in the transfer region 6. In the embodiment shown in the drawings, with particular reference to FIG. 7, each mushroom gripper 22 of the mushroom sorting unit 20 may be guided on the guide rail 25 via a support wheel 28 to control the height of the grippers 22. Each gripper 22 may have two body parts vertically displaceable with respect to one another, a first body part guiding lateral movement of the gripper body 22 and a second body part, vertically displaceable on the first body part, controlling the height of the gripping members 23,24 of the respective gripper 22.

A mechanical operating mechanism is optionally provided for controlling the separation of the gripping members 23,24 of each mushroom gripper 22 to control the picking up of mushrooms by the grippers 22 in the transfer region and the release of the mushrooms in the sorting region, as will be described in more detail below.

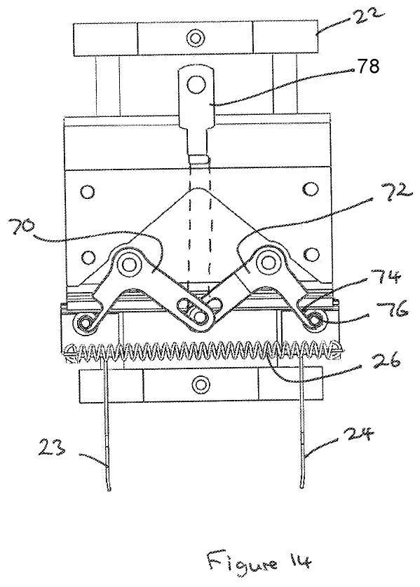

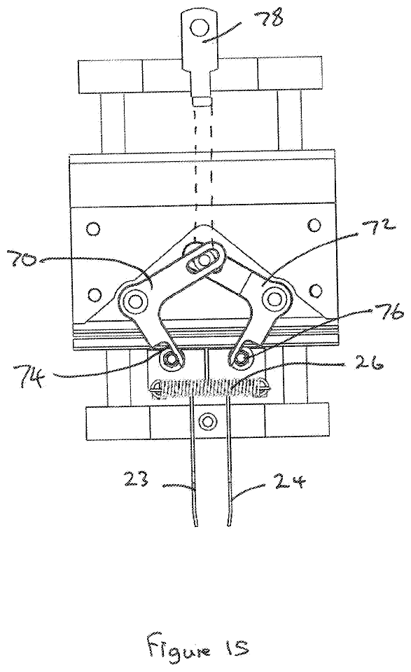

In the embodiment shown in FIGS. 13 to 15, each gripper 22 includes a pair of opposed operating levers 70,72 mounted adjacent the upper ends of the gripping members 23,24 thereof. Each operating lever 70,72 has a cam face 74 adapted to engage a follower 76 on a respective gripping member 23,24, whereby rotation of the operating lever 70,72 causes the cam face 74 to act against the cooperating follower 76 of the respective gripping member 23,24.

An operating member 78 is mounted adjacent the operating levers 70,72 to act against the levers 70,72 to rotate the levers 70,72 in opposite directions such that the cam faces 76 act on the cam followers 76 of the gripping members 23,24 to urge the gripping members 23,24 away from one another, against the action of the return spring 26, as the operating member 78 is displaced.

The operating member 78 of each gripper 22 has one end engaging respective portions of the operating levers 70,72 and an opposite end defining a follower adapted to selectively engage respective control surfaces arranged to control the movement of the operating member 78 and thus the spacing of the gripping members 23,24 of each gripper 22 along the path of the grippers 22.

The follower may be defined by a roller 80 provided at the opposite end of the operating member 78 for engaging the control surfaces. By such arrangement, the displacement of the operating member 78 by the action of the control surfaces on the operating member 78 can be used to determine the spacing of the gripping members 23,24 of each gripper 22. In the embodiment shown the operating member 78 extends upwardly from each gripper 22.

Each mushroom gripper 22 may be associated with a release mechanism adapted to release a mushroom held by the gripping members of a respective mushroom gripper 22 at a selected one or a plurality of positions as a function of the distance between the gripping members 23,24 of the respective mushroom gripper 22 when a respective mushroom is held therein, thereby sorting the mushrooms by size. A respective punnet or punnet (not shown) may be located at each of the plurality of selected positions for receiving mushrooms dropped by the grippers 22 at such position.

The release mechanism may include a control surface arranged to engage the follower 80 of the operating member 78 of each gripper 22 to urge gripping members 23,24 apart, thus release a mushroom held therein, at a respective one of the plurality of positions depending upon the distance between the gripping members of the respective gripper. The control surface may include a linear ramp arranged at an acute angle to the direction of travel of the mushroom grippers 22, the follower 80 of the operating member 78 of the each gripper 22 engaging the ramp when in the sorting region such that the respective operating levers 70,72 urge the gripping members 23,24 away from one another to facilitate release of the mushroom held thereby at a predetermined position as a function of the distance between the gripping members 23,24 of each gripper 22 and thereby as a function of the size of the mushroom carried by the respective gripper 22.

The operating member 78 of each mushroom gripper 22 extends vertically upwardly from the respective gripper 22, and thus the position along the path of the grippers 22 at which the follower 80 of the operating member 78 engages the grading bar may vary as a function of the distance between the gripping members 23,24 of the respective gripper 22. Thus the release mechanism is adapted to grade the mushrooms 1 and release them at predetermined locations along the sorting region, which may entail dropping the mushrooms 1 into respective punnets, as a function of the size of the mushrooms.

Means may be provided for automatically removing full punnets and bringing an empty punnet into position when full. Each punnet may be located on a weighing mechanism whereby the punnet is replaced with an empty punnet when the weight of mushrooms collected therein reaches a predetermined weight. Full punnets may be transferred onto a conveyor for passage to a packaging or wrapping station.

The mushroom handling apparatus in accordance with the present invention provides a compact and efficient may of transferring mushrooms from the tiered growing beds of the shelving to a sorting region where the mushrooms are automatically sorted by size and delivered to punnets, greatly reducing the labour requirements of the mushroom growing process. By mounting both the mushroom transfer unit and mushroom sorting unit on a support frame carried by the shelving a particularly compact and reliable mushroom handling apparatus is provided which overcomes the disadvantages of the prior art.

The invention is not limited to the embodiments described herein but can be amended or modified without departing from the scope of the present invention, which is intended to be limited only by the scope of the appended claims as interpreted according to the principles of patent law including the doctrine of equivalents.

1. A mushroom handling apparatus for handling mushrooms grown in a plurality of vertically spaced mushroom growing beds arranged on trays in vertically tiered relationship on shelving, said apparatus comprising:
a frame;
a mushroom transfer device mounted on said frame and incorporating a first guide adapted to extend circumferentially around the mushroom growing beds;
a plurality of mushroom holders mounted on said first guide at spaced locations therealong;
a drive associated with said first guide and configured to move said mushroom holders to transfer mushrooms carried thereon between the mushroom growing beds and a mushroom transfer region at one end of said frame;
a mushroom handling device mounted adjacent said mushroom transfer device and incorporating a second guide, a portion of said second guide overlapping at least a portion of said first guide in the transfer region;
a plurality of mushroom grippers mounted on said second guide wherein said mushroom holders and said mushroom grippers are indexed on said first and second guides such that said mushroom grippers are aligned with respective mushroom holders in the transfer region to facilitate transfer the mushrooms between said holders of said mushroom transfer device to said grippers of said mushroom handling device; and
a lifting device for adjusting the height of said frame with respect to the shelving to bring said mushroom transfer device and said mushroom handling device into vertical alignment with selected ones of the vertically tiered growing beds.

2. The apparatus of claim 1, wherein said frame is adapted to be supported on the shelving and/or an adjacent lifting frame.

3. The apparatus of claim 2, further comprising a selectively operable lock for locking said frame at a selected height on the shelving.

4. The apparatus of claim 3, wherein said lock is biased to a locked position to prevent uncontrolled movement of said frame with respect to the shelving, an actuator being provided for selectively releasing said lock from the locked position.

5. The apparatus of claim 1, wherein a cutting device is provided for cutting off the stems of mushrooms as the mushrooms are carried by said mushroom holders of said mushroom transfer device.

6. The apparatus of claim 5, wherein said cutting device is located on said frame in the transfer region.

7. The apparatus of claim 1, wherein each mushroom holder of said mushroom transfer device comprises a base portion and a pair of spaced apart fingers extending outwardly from said base portion to be located on either side of the stem of a mushroom such that the cap of the mushroom is supported upon said fingers.

8. The apparatus of claim 1, wherein each mushroom gripper of said mushroom handling device comprises a pair of mushroom gripping members displaceable towards and away from one another to selectively engage either side of the cap of one of the mushrooms carried by an adjacent one of said mushroom holders, wherein said gripping members of each gripper are arranged to engage mushrooms carried by respective mushroom holders when aligned therewith to transfer the mushrooms between said first and second guides in the transfer region.

9. The apparatus of claim 8, wherein each mushroom gripper is vertically displaceable at least in the transfer region to facilitate transfer of one of the mushrooms from a respective one of said mushroom holders to a respective one of said mushroom grippers.

10. The apparatus of claim 9, wherein said gripping members of each gripper are biased towards one another to grip one of the mushrooms therebetween, an actuator being provided for selectively displacing said gripping members away from one another.

11. The apparatus of claim 10, further comprising a controller arranged for operating said actuator of each mushroom gripper of said mushroom handling device, at least in the transfer region, such that said gripping members selectively engage either side of the cap of a mushroom carried by an adjacent mushroom holder of said mushroom transfer device to engage mushrooms carried by respective mushroom holders when aligned therewith to transfer mushrooms between said first and second guides in the transfer region.

12. The apparatus of claim 11, wherein said actuator of each mushroom gripper comprises an operating member extending from each mushroom gripper and having an inner end acting against respective operating levers to urge the respective gripping members away from one another, said controller comprising at least one control surface acting upon an outer end of said operating member to control the spacing between said gripping members of each mushroom gripper as said gripper moves past said control surface.

13. The apparatus of claim 1, wherein each mushroom gripper of said mushroom handling device is associated with a release mechanism adapted to release one of the mushrooms held by a respective one of said mushroom grippers at a selected one or a plurality of positions in a sorting region as a function of the distance between said gripping members of each mushroom gripper when a respective one of the mushrooms is held therein, thereby sorting the mushrooms by size.

14. The apparatus of claim 13, further comprising a respective punnet at each of said plurality of selected positions for receiving the sorted mushrooms.

15. The apparatus of claim 13, further comprising a controller for operating said actuator of each mushroom gripper of said mushroom handling device, at least in the transfer region, such that said gripping members selectively engage either side of the cap of a mushroom carried by an adjacent mushroom holder of said mushroom transfer device to engage mushrooms carried by respective mushroom holders when aligned therewith to transfer mushrooms between said first and second guides in the transfer region, wherein said release mechanism includes a control surface defining a grading member arranged to engage said operating member of said operating mechanism of each gripper as it passes through the sorting region, to release a mushroom held therein at a respective one of said plurality of positions depending upon the distance between said gripping members of the respective gripper.

16. The apparatus of claim 15, wherein said control surface defining said grading member is arranged at an inclined angle with respect to path said mushroom grippers in the sorting region.

17. The apparatus of claim 1, wherein said first guide comprises an endless flexible member extending between guide members.

18. The apparatus of claim 1, wherein said second guide comprises a guide rail upon which said plurality of mushroom grippers are supported and/or guided.

19. A mushroom growing assembly comprising shelving defining a plurality of vertically spaced mushroom growing beds arranged in vertically tiered relationship, and said mushroom handling apparatus of claim 1 mounted on said shelving.

20. The mushroom growing assembly of claim 19, wherein mushrooms are transferred from the growing beds to the transfer region via said mushroom transfer device and from the transfer region to a sorting region via said mushroom handling device.

21. The mushroom growing assembly of claim 20, wherein said mushroom handling device is adapted to sort the mushrooms by size and to deliver sorted mushrooms to respective punnets.
